(19) United States
(12) Patent Application Publication
(10) Pub. No.: US 2006/0055585 A1
(43) Pub. Date: Mar. 16, 2006

(54) Radar system

(75) Inventors: Toshiyuki Nagasaku, Kokubunji (JP); Hiroshi Kondoh, Fuchu (JP)

Correspondence Address: Stanley P. Fisher;Reed Smith LLP, Suite 1400, 3110 Fairview Park Drive, Falls Church, VA, 22042-4503, US

(73) Assignee: Hitachi, Ltd.

(21) Appl. No.: 11/025,974

(22) Filed: Jan. 3, 2005

(30) Foreign Application Priority Data
Jun. 2, 2004 (JP) 2004-164097

(51) Int. Cl. G01S 13/62

(52) U.S. Cl. 342/28; 342/118; 342/114; 340/545.3

(57) ABSTRACT

There is provided a radar system for improving distance resolution while preventing generation of ghost by an object located in the outside of the effective distance for detection. In this radar system, the signal generated by a voltage-controlled oscillator is transmitted only for the predetermined period by turning ON a switch only for the predetermined time length t1 with an interval of the predetermined period t2. Moreover, the time for detecting the receiving signal is limited to the predetermined period t3 (=t1) from the timing of transmission of the transmitting signal and the reflection signal from the object located in the outside of the effective distance is eliminated by limiting a local signal inputted to a mixer to the period t1.

### CLAIM OF PRIORITY

The present invention claims priority from Japanese application JP 2004-164097 filed on Jun. 2, 2004, the content of which is hereby incorporated by reference into this application.

### FIELD OF THE INVENTION

The present invention relates to a radar system for detecting distance up to an object, relative velocity and direction by receiving the reflected wave of the electromagnetic wave radiated to the object and returned therefrom after reflection and particularly to a radar system using the electromagnetic waves of a couple of signals having the frequencies which are a little different or the frequency-modulated signals.

### BACKGROUND OF THE INVENTION

The radar system for detecting distance, relative velocity, and direction of an object by radiating the electromagnetic wave and receiving the wave returning from the object after reflection has been widely used. Typical radar system of this type includes a trespasser monitoring radar which issues an alarm by detecting a person or an animal invading into the monitoring area and a vehicle radar used for an adaptive cruise control system for vehicle.

In the radar system, a method for detecting the distance up to an object is classified into a two-frequency CW (continuous wave) system using two continuous wave signals having the frequencies which are a little different and an FMCW (Frequency Modulation Continuous Wave) system using the continuous wave signal which is changed continuously in the frequency.

As an example of the two-frequency CW system, an example is disclosed in the Patent Document 1, in which different two couples of two-frequencies are used respectively for long distance measurement and short distance measurement and an error detection in the short distance measurement is prevented by roughly detecting an obstacle located in the outside of the detection area with the two-frequency for long distance measurement. Moreover, another example of the two-frequency CW system, an example is disclosed in the Patent Document 2, in which deterioration in accuracy generated through multiple reflections between an antenna and the object by obtaining the reference phase difference at least from one period of the phase difference signal of the receiving signal.
[Patent Document 1] JP-A No. 166443/1996
[Patent Document 2] JP-A No. 39009/1998

### SUMMARY OF THE INVENTION

In order to describe the problems to be solved in the present invention, the principle of the two-frequency CW system will be described first.

FIG. 14 illustrates an example of the basic structure of a radar system of the two-frequency CW system. The two-frequency CW system transmits two signal frequencies which are a little different with each other as the transmitting signals. In the example of FIG. 14, these transmitting signals are generated with a voltage-controlled oscillator 1 which is controlled with a frequency control voltage from a control voltage generator (CONT) 2. Here, the transmitting signals S_{1TX} and S_{2TX} are expressed by the formulae (1) and (2).
S_{1TX}=A_{TX} sin(2πf₁t) (1)
S_{2TX}=A_{TX} sin(2πf₂t) (2)

Here, f1, f2 are frequencies of the transmitting signals, and A_{TX} is a signal amplitude of the transmitting signals.

This signal is radiated from the antenna 4. The receiving signals S_{1RX}, S_{2RX} for the transmitting signals S_{1TX}, S_{2TX} are expressed by the formulae (3) and (4).

$$\begin{matrix}{S}_{1 RX} = {A}_{RX} sin [ 2 π ( {f}_{1} + {f}_{d1} ) t - 4 π {f}_{1} \frac{R}{C} ] & ( 3 ) \\ {S}_{2 RX} = {A}_{RX} sin [ 2 π ( {f}_{2} + {f}_{d2} ) t - 4 π {f}_{2} \frac{R}{C} ] & ( 4 )\end{matrix}$$

A_{RX} is a signal amplitude of the receiving signals, f_{d1}, f_{d2} are Doppler shift generated by the relative velocity between the radar system and an object, R is distance between the radar system and an object, and c is the velocity of light.

Here, when Δf=f1−f2<<f1, f2, following relationship can be obtained.
f_{d1}≈f_{d2}=f_{d}

This signal is applied to a mixer 3 to generate the low frequency signals S_{1IF} and S_{2IF} having only the Doppler frequency element expressed by the formulae (5) and (6).

$$\begin{matrix}{S}_{1 IF} = {A}_{IF} sin [ 2 π {f}_{d} t - 4 π {f}_{1} \frac{R}{C} ] & ( 5 ) \\ {S}_{2 IF} = {A}_{IF} sin [ 2 π {f}_{d} t - 4 π {f}_{2} \frac{R}{C} ] & ( 6 )\end{matrix}$$

Here, A_{IF} is a signal amplitude of the low frequency signal. This signal is subjected to the process such as the Fast Fourier Transfer with a signal processing circuit (PRC) 6 to calculate a phase difference and a Doppler frequency.

Here, the distance R up to the object can be expressed as the formula (8) from the phases of both signals expressed by the formula (7) and the distance is calculated with the signal processing circuit 6.

$$\begin{matrix}Δϕ = 4 π ( {f}_{2} - {f}_{1} ) \frac{R}{C} = 4 πΔ f \frac{R}{C} & ( 7 ) \\ R = \frac{c Δϕ}{4 πΔ f} & ( 8 )\end{matrix}$$

As described above, since distance is measured from phase difference in the two-frequency CW system, this system has a merit that it is no longer required to sweep the frequency for wider range and therefore it is suitable for higher accuracy and resolution in measurement of distance. Moreover, as expressed by the formula (8), since phase difference Δφ is proportional to frequency difference Δf, amount of variation of phase difference Δφ for distance R, namely gradient of Δφ for R becomes large and resolution of distance can be improved.

In the formula (8), the range for uniquely obtaining distance R (called “effective distance” in this specification) Rₘₐₓ is defined with the range where phase difference Δφ is equal to or less than 180 degrees. However, when an object existing in the position where Δφ is equal to or larger than 180 degrees is received, the signal of this object is calculated under the assumption that the object is located in the position within the effective distance Rₘₐₓ which should not actually be considered. As a result, the radar system generates “ghost” because it erroneously judges that the object exists in the position where nothing is actually located.

In order to prevent generation of such ghost, Δf must be set so that the effective distance Rₘₐₓ becomes larger than the detectable limit distance which is determined with the radar performance such as radiation power of transmitter and sensitivity of receiver which are forming the radar system. In this case, when Rₘₐₓ is larger, Δf becomes small and distance resolution is lowered.

On the contrary, if it is attempted to make larger Δf in order to raise distance resolution, Rₘₐₓ becomes small. As described above, the trade-off relationship exists between Δf and Rₘₐₓ.

In the case of a vehicle radar system, an object to be detected is an ordinary vehicle or a large duty truck. These are substances which reflect particularly a large amount of electromagnetic wave among those existing in the environment for use and show a little difference in amount of reflection of electromagnetic wave in accordance with types of vehicle. Therefore, the detectable limit distance and effective distance Rₘₐₓ determined by the performance of radar system can be set to almost equal values.

Meanwhile in the case of the radar system for monitoring a trespasser for detecting a person who is intruding into the detectable range, a human body is mainly selected as an object to be detected. In general, a human body shows a very small amount of reflection of electromagnetic wave such as about 1/10 to 1/1000 in comparison with a vehicle. It is assumed here that the detection range is set to several tens meters and performance of radar system is set to the range for detecting a human body located within the preset range. In this case, since the reflected signal from a substance which shows a large amount of reflection of electromagnetic wave such as a vehicle existing in the area separated by several hundreds meters becomes almost equal to the reflected signal from a person within the range of several tens meters, the vehicle existing in the distant place is erroneously detected as a ghost as if it were within the detection range. In order to prevent generation of such ghost, the effective distance Rₘₐₓ must be set to several hundreds meters. As an example, the radar system having the performance to detect up to a human body within the distance of 50 meters can spread the detection range by about 400 meters for vehicles. Accordingly, when it is assumed that vehicles run in the detection range, the effective distance Rₘₐₓ must be set to about 400 meters in order to prevent generation of ghost. In this case, Δf becomes small in comparison with that when the effective distance Rₘₐₓ is set to 50 meters.

Meanwhile, Δf must be increased to improve the distance resolution. However, if Δf is increased, effective distance Rₘₐₓ becomes small resulting in the possibility of generation of ghost. Accordingly, distance resolution cannot be increased sufficiently.

As described above, in the radar system for detecting substances such as human bodies showing a small amount of reflection of electromagnetic wave like the trespasser detection radar, the effective distance Rₘₐₓ must be set to several times of the detection limit distance of the target to be detected, resulting in the problem that distance resolution cannot be increased sufficiently.

Moreover, even in the radar system used for the adaptive cruise control system, increase of Δf is a certainly effective means for improvement in distance resolution. However, when the performance of radar system exceeds the requested performance to a large extent, here rises a problem that Δf cannot be increased sufficiently and thereby distance resolution cannot be enhanced because the signal is received from the object located in the outside of effective distance Rₘₐₓ as in the case of the trespasser monitoring radar and ghost is probably generated.

An object of the invention is to provide a radar system which can improve distance resolution while it is preventing generation of ghost generated by objects located in the outside of the effective distance.

The problems described above of the present invention can be effectively solved with a radar system of the present invention comprising a signal generator for generating the transmitting signal, an antenna for radiating the electromagnetic wave by inputting the transmitting signal outputted from the signal generator, a receiving antenna for receiving the electromagnetic wave reflected by an object, and a detector for detecting distance up to the object from the receiving signal outputted from the receiving antenna, in which the transmitting signal exists in the first period with an interval of the second period, and the detector detects the distance up to the object by processing the receiving signal received up to the third period from start of the first period. With employment of such means, interference reflection signals can be eliminated by setting the first period shorter than the period required by the signal reflected from the object located further than the effective distance to reach.

According to a profile of the present invention, it is expected that the radar system can improve distance resolution through prevention of generation of ghost.

### BRIEF DESCRIPTION OF THE DRAWINGS

FIG. 1 is a block diagram for describing a first embodiment of the radar system of the present invention;

FIG. 2 is a circuit diagram for describing a circuit example of a voltage-controlled oscillator used in the first embodiment;

FIG. 3 illustrates signal conditions in the present invention;

FIG. 4 illustrates signal conditions in the first embodiment;

FIG. 5 is a plan view for describing a module mounting a radar system of the first embodiment;

FIG. 6 is a block diagram for describing a second embodiment of the present invention;

FIG. 7 illustrates frequency conditions of the signals in the second embodiment;

FIG. 8 is a block diagram for describing a third embodiment of the present invention;

FIG. 9 is a timing chart for describing the embodiments of the present invention;

FIG. 10 is a diagram for describing a fourth embodiment of the present invention;

FIG. 11 is a diagram for describing a fifth embodiment in which the present invention is used for a trespasser monitoring radar;

FIG. 12 is a diagram for describing the fifth embodiment;

FIG. 13 is a diagram for describing a sixth embodiment in which the present invention is used for a vehicle radar; and

FIG. 14 is block diagram for describing the conventional two-frequency CW radar.

### DETAILED DESCRIPTION OF THE PREFERRED EMBODIMENTS

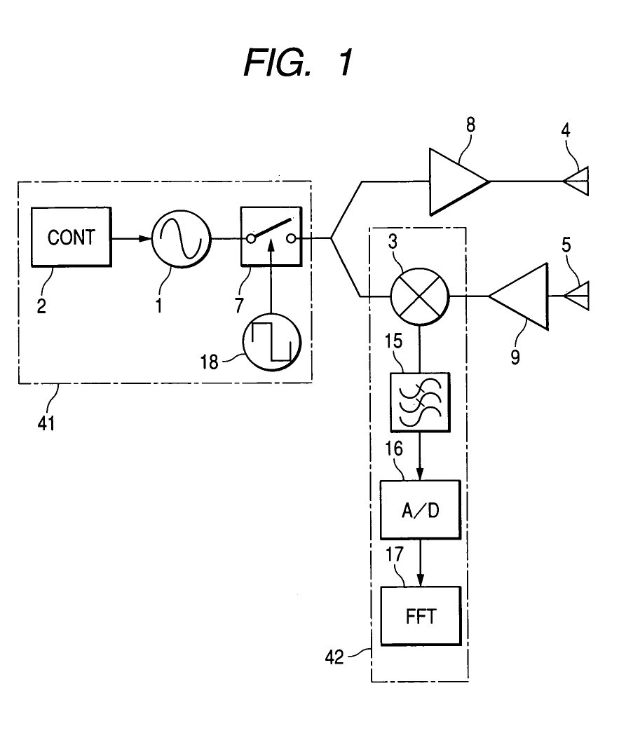

A radar system of the present invention will be described in detail with reference to the preferred embodiments illustrated in the accompanying drawings. The like numerals in FIGS. 1, 6, and 8 designate the identical or the like elements.

First, the operation principle of the preferred embodiments will be described by considering an example of a two-frequency CW radar.

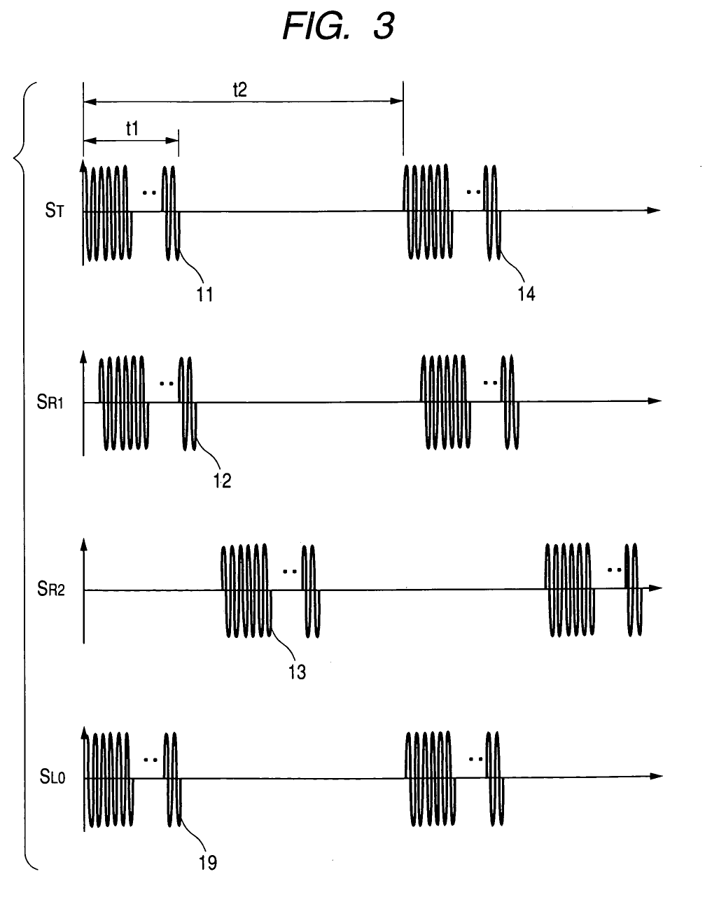

The radar system transmits, as illustrated in FIG. 3, a transmitting signal 11 of the transmitting signal ST only within the predetermined time length (first time length) t1. The time length t1 for transmitting the transmitting signal 11 is expressed by the formula (9).

$${t}_{1} = \frac{2 {R}_{spec1}}{C} \qquad ( 9 )$$

Here, R_{spec1} is the maximum detection distance given upon consideration of the required specification of the radar system and satisfies the following relationship for the effective distance Rₘₐₓ.
R_{spec1}≦Rₘₐₓ

Rₘₐₓ is the distance where phase difference Δφ becomes 180 degrees in the two-frequency CW system as described above and is given by the following formula.

$${R}_{max} = \frac{C}{4 Δ f}$$

Moreover, a time interval (interval of the second time) t2 between the transmitting signal pulse 11 and the next transmitting signal 14 is given the following formula (10).

$${t}_{2} > \frac{2 {R}_{lim}}{C} + {t}_{1} \qquad ( 10 )$$

Here, Rₗᵢₘ is the detection limit distance of the object which shows the maximum amount of reflection of the electromagnetic wave estimated from the performance of radar system and environment for use. In FIG. 3, the receiving signal from the object located nearer than the distance R_{spec1} is designated as S_{R1}, and the reflection signal from the object located further than the distance R_{spec1}, as S_{R2}. As illustrated in the same figure, the reflection signal 12 from the object located nearer than the distance R_{spec1} is received with a shorter time delay because the propagation distance of electromagnetic wave is short, while the reflection signal 13 from the object located further than the distance Rspec1 is received with a longer time delay because the propagation distance is longer. Accordingly, only the reflection signal from the object within the distance R_{spec1} can be detected and generation of ghost by the reflection signal from the object located in the outside of the distance Rₘₐₓ can also be suppressed by limiting the time required for detecting this receiving signal within the constant period t₃ (third period) expressed by the following formula after transmission of the transmitting signal.

$${t}_{3} = \frac{2 {R}_{spec1}}{C}$$

In the above description, single frequency is considered for simplifying the description, but in the case of the two-frequency CW system, the signals of two frequencies are radiated simultaneously or radiated through the switching of the transmission time.

Measurement of distance up to an object is possible using the formula (8) and such distance can be measured with higher accuracy and resolution.

In more general, with inclusion of the two-frequency CW system, the present invention is a radar system for detecting the distance up to an object by radiating the electromagnetic wave and receiving the returning electromagnetic wave reflected from the object, in which the electromagnetic wave is radiated only for the predetermined period t₁ with the predetermined interval of t₂ and only the signal received within the predetermined period t₃ after radiation of the electromagnetic wave is processed.

### FIRST EMBODIMENT

FIG. 1 is a block diagram of a first embodiment of a radar system of the present invention. In FIG. 1, numeral 1 designates a voltage-controlled oscillator for generating for generating the signal of the desired frequency; 2, a control voltage generator (CONT) 2 for generating a control voltage for controlling the voltage-controlled oscillator 1. The voltage-controlled oscillator 1 generates two signals of frequencies f1, f2 through the switching of the timings under the time control of the control voltage by the control voltage generator 2.

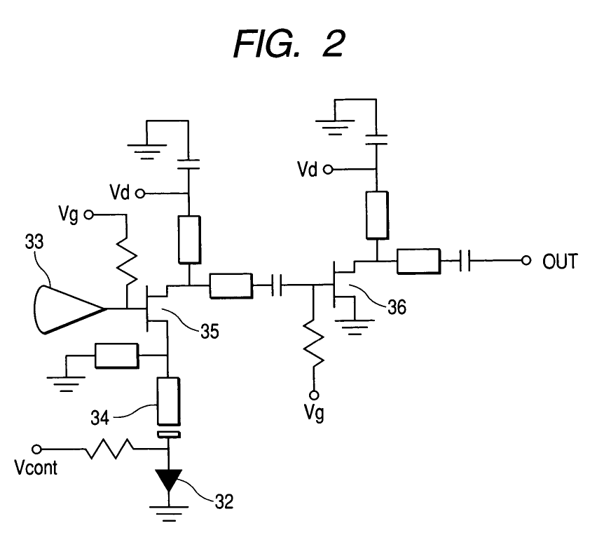

Here, an example of structure of the voltage-controlled oscillator 1 is illustrated in FIG. 2. The voltage-controlled oscillator 1 of FIG. 2 is a circuit for generating ultra-high frequency signal such as a millimeter wave. This circuit is formed using a HEMT (High Electron Mobility Transistor) 35 as an active device. Operations of this circuit will be described below. The HEMT 35 for oscillation oscillates in the predetermined frequency under the condition that frequency of negative resistance generated by a radial stub 33 is adjusted and moreover that a resonator 34 of the open stub type is set to the ¼ length for the wavelength of the frequency to be oscillated. The end part of the open-stub type resonator 34 is connected with a varactor diode 32 for adjustment of oscillation frequency. Since the control voltage V_{cont} is impressed to the varactor diode 32, the oscillation frequency is switched two frequencies f1 and f2 in the two-frequency CW system. The signal generated by the HEMT 35 for oscillation is amplified by a HEMT 36 and is then outputted from an output terminal OUT. A power supply voltage Vd is supplied to the HEMTs 35, 36.

In FIG. 1, the signal generated by the voltage-controlled oscillator 1 is controlled with a clock generator 18 to become ON, with a high frequency switch 7, only for the time length (length of first period) t1 given by the formula (9) in the period of time (interval of second period) t2 given by the formula (10). This signal is distributed to the transmitting side and receiving side and the signal in the transmitting side is used as the transmitting signal, while the signal in the receiving side is used as the local signal inputted to a mixer 3. In above description, a signal generator 41 for generating the transmitting signal is formed of the voltage-controlled oscillator 1, control voltage generator 2, high frequency switch 7, and clock generator 18.

The signal distributed to the transmitting side is amplified with a power amplifier 8 and is thereafter radiated from an antenna 4. The signal reflected by an object is received with a receiving antenna 5 and is mixed with a local signal with a mixer 3 via a low noise amplifier 9. Conditions of the signals are illustrated in FIG. 3. A reflection signal 12 from the object located nearer than the R_{spec1} for the transmitting signal 11 reaches the radar system with a shorter time delay. Meanwhile, the receiving signal 13 from the object located further than the R_{spec1} reaches with a larger time delay because the propagation distance of signal is longer. These receiving signals are inputted to the mixer 3 and mixed with the local signal 19. In this timing, the local signal 19 is also switched in the same timing as the transmitting signal. Therefore, the low frequency signal corresponding to the Doppler frequency is generated for the signal received within the period t1 but since the local signal to be inputted to the mixer 3 does not exist for the signal 13 having reached the receiving antenna with a time delay longer than the period t1, the low frequency signal is not generated. As described above, the period for detecting the receiving signal is limited within the constant period (third period) t3 from transmission of the transmitting signal. In this first embodiment, t3 is set equal to t1 (t3=t1), but t3 may be set to a value near to t1 in accordance with the target performance. In this case, another high frequency switch which turns ON during the time length t3 is connected to the voltage-controlled oscillator 1 and an output signal of this high frequency switch is replaced with the local signal 19 inputted to the mixer 3.

An output signal of the mixer 3 is subjected to A/D conversion with an A/D converter 16 through a low-pass filter 15 and is then processed for fast Fourier transformation (FFT) in a fast Fourier transformer (FFT) 17. Distance up to the object can be detected from this signal process. Moreover, it is also possible to extract velocity and direction of the object. Accordingly, a detector 42 for detecting distance up to the object is constituted by the mixer 3, low-pass filter 15, A/D converter 16, and fast Fourier transformer (FFT) 17.

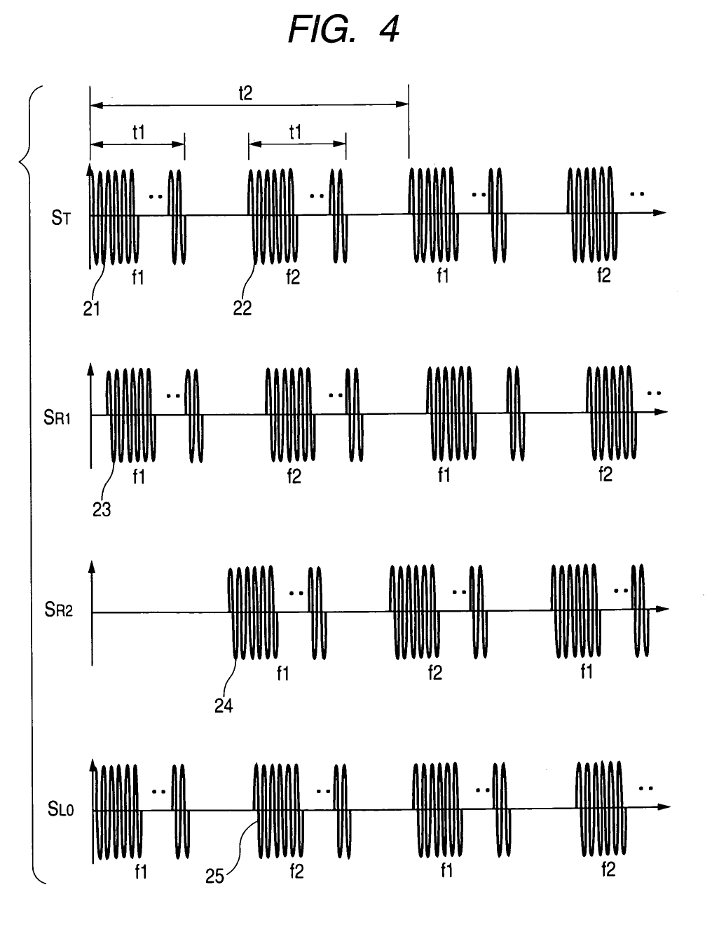

In the system for switching a couple of frequencies in time like this embodiment, when a switching interval of two frequencies f1, f2 is shorter than the period t2 and two-frequency signals switched are arranged within the range of t2, the transmitting signal 21 of frequency f1 and the transmitting signal of frequency f2 can be transmitted alternately as illustrated in FIG. 4. In FIG. 4, the signal 23 of the receiving signal S_{R1} is the reflection signal from the object located nearer than the effective distance Rₘₐₓ, while the signal 24 of the receiving signal S_{R2} is the reflection signal from the object located further than the Rₘₐₓ. Here, as illustrated in FIG. 4, in some cases, the signal 24 generated when the transmitting signal of frequency fl is reflected from the object located further than the R_{spec1} and the local signal 25 of frequency f2 are inputted to the mixer. In this case, the low frequency signal f_{IF} to be generated is expressed by the following formula.
f_{IF}=|f₁−f₂|f_{d} or f_{IF}=|f₁−f₂|−fd

Here, fd is the Doppler frequency. However, since the Doppler frequency is generally very low, the signal f_{IF} can be eliminated by using the low-pass filter 15 which passes the low frequency signal. As an example, when the signal of 24 GHz is used for the frequencies f1, f2, the Doppler frequency fd generated for a substance running in the speed of 100 km/h becomes about 4.4 khz. Therefore, it is enough to set |f1-f2| to the value which is sufficiently larger than 4.4 khz. In the present invention, it is desirable to set Δf=|f1-f2| to a larger value in order to improve the distance resolution. As a result, the present invention satisfies this condition.

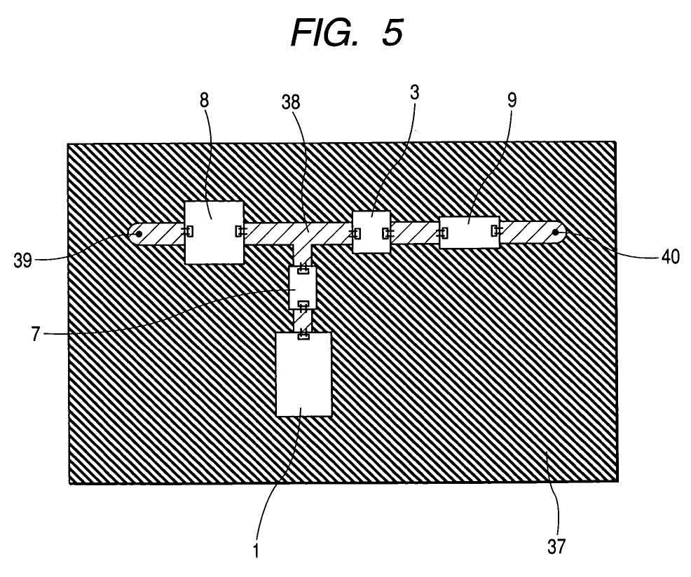

An example of the module of the circuit illustrated in the block diagram of FIG. 1 is illustrated in FIG. 5. In this example, the voltage-controlled oscillator 1, power amplifier 8, switch 7, mixer 3, and low noise amplifier 9 are all formed of MMIC (Monolithic Microwave Integrated Circuit) . Respective MMICs are allocated on a high frequency substrate 37 and are connected with signal lines 38 formed on the high frequency substrate 37 with the bonding wires. As the material of high frequency substrate of this type, alumina is used.

An output of the power amplifier 8 is fed to the antenna 4 from an output terminal 39. Moreover, the signal received by the receiving antenna 5 is fed to the low noise amplifier 9 from a receiving terminal 40. On the high frequency substrate, a DC line for impressing the power supply to the MMICs also exists, but it is not illustrated in FIG. 5 for simplifying the drawing. In this example, each circuit is formed of MMIC but similar operations can also be realized by using individual components as required. Moreover, when sufficient transmitting power can be obtained, the power amplifier 8 may be eliminated. In the same manner, when sufficient sensitivity can be obtained, the low noise amplifier 9 may also be eliminated. In addition, the switch 7 is located just after the oscillator 1, but when similar effect can be attained, it may be located in the other position or a plurality of switches 7 may also be used.

According to this embodiment, generation of ghost due to the reflection signal from the object can be prevented by eliminating the reflection signal from the object located further than the effective distance Rₘₐₓ. Therefore, it is expected to realize higher resolution of the radar system.

In this embodiment, the method for switching two frequencies with time has been described, but the similar effect can also be attained with the system for simultaneously transmitting the signals of two frequencies.

From above description, this embodiment is a radar system for radiating the electromagnetic wave only for the predetermined period t1 with the predetermined time interval t2 and processing only the signal received within the predetermined period t3 from radiation of the electromagnetic wave, in the radar system of the two-frequency CW system for detecting the distance up to an object by radiating the two electromagnetic waves of the frequencies which are different a little and receiving the electromagnetic wave reflected by the object.

### SECOND EMBODIMENT

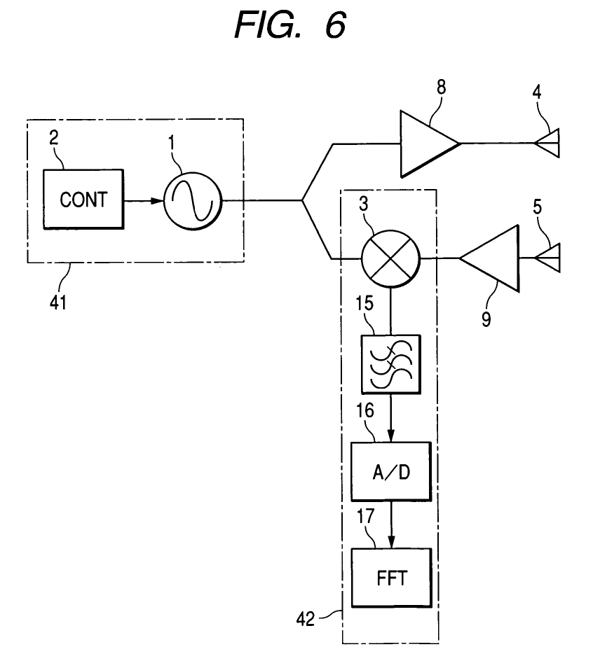

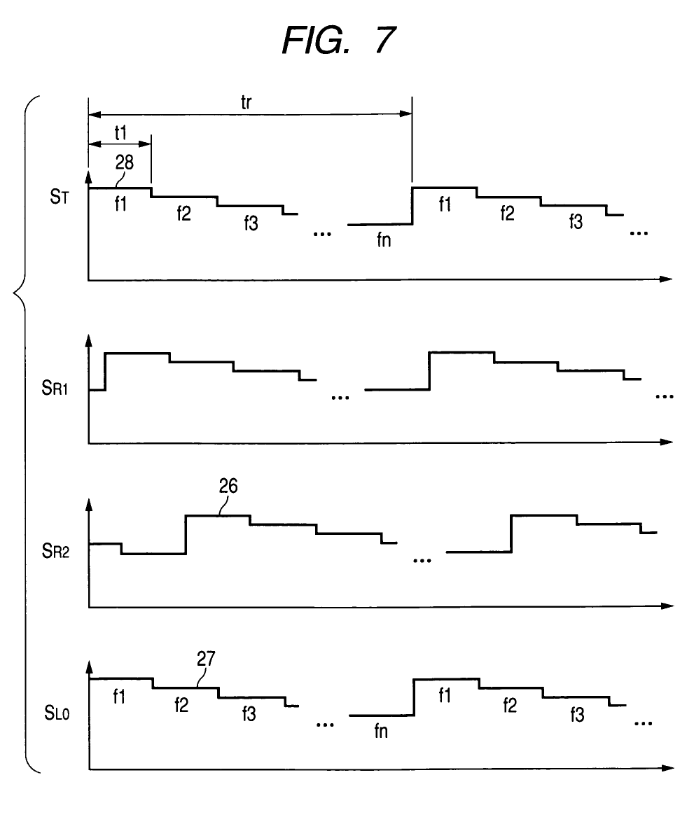

FIG. 6 is a block diagram of a second embodiment. Moreover, FIG. 7 illustrates the conditions of the signals in this embodiment in which the frequency is plotted on the vertical axis, while time on the horizontal axis. In this embodiment, in place of the switching of the transmitting signal in the shape of the pulse, the frequency is sequentially switched in every period t1 (predetermined period) like the transmitting signal ST of FIG. 7. The frequencies f1 to fn obtained by the switching are repeated with the period tr. As the period tr, t2 expressed by the formula (10) can be employed.

In FIG. 7, the receiving signal S_{R1} indicates the reflection signal from the object located nearer than the effective distance Rₘₐₓ, while receiving signal S_{R2} indicates the reflection signal from the object located further than the Rₘₐₓ. When the object is further than the Rₘₐₓ, the signal 26 obtained when the transmitting signal 28 of frequency f1 is reflected from the object is mixed with the local signal 27 of the frequency other than f1 in the mixer 3 and thereby the low frequency signal is generated. When the transmitting signal has the frequency other than f1, following relationship can be established.
f_{IF}=|fᵢ−fⱼ|+f_{d} or f_{IF}=|fᵢ−fⱼ|−f_{d}
(i, j=1, 2, 3, . . . , n), where i≠j

However, as described above, the signal due to this frequency difference can be eliminated using the low-pass filter 15 by setting the frequency difference |f₁−fⱼ| of the transmitting signal to a sufficiently large value. Accordingly, the receiving signal received within the period t1 from the time of frequency switching is processed with the A/D converter 16 and signal processing circuit 17 to detect the distance up to the object. Distance measurement in the two-frequency CW system can be realized using two signals having desired frequencies among f1 to fn.

According to this embodiment, the switch circuit may be eliminated because the effect signal to that when the short pulse is used can be obtained by sequentially switching the control voltage. In general, the switch circuit changes its impedance to a large extend in the ON and OFF status. Therefore, the operating conditions of the oscillator 1 connected with the switch are sometimes changed largely in the ON and OFF status. This embodiment results in the effect that the switch circuit having such operation can be eliminated.

From above description, this embodiment is a radar system for switching the frequency of the electromagnetic wave to be radiated in every predetermined period t1 and processing only the signal received within the predetermined period t1 from the switching time of the frequency, in the radar system for detecting the distance up to the object by radiating the electromagnetic wave and receiving the electromagnetic wave reflected from the object.

### THIRD EMBODIMENT

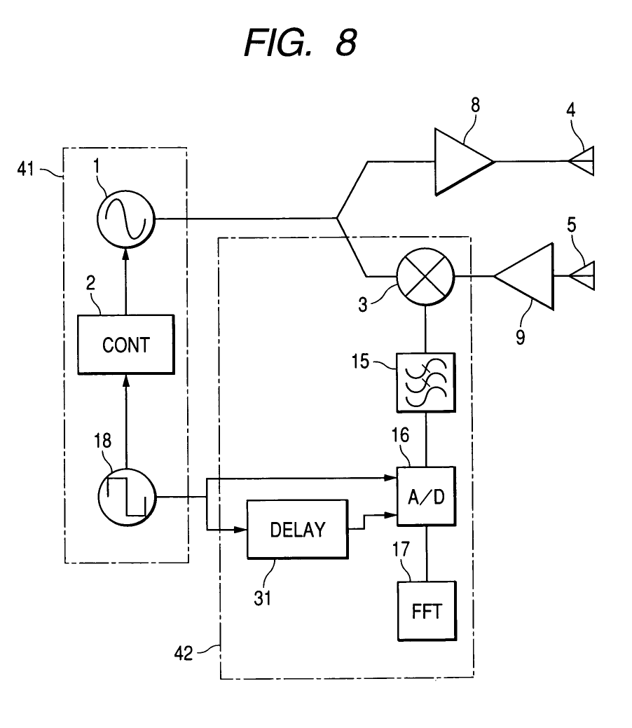

FIG. 8 is a block diagram of a third embodiment of the present invention. In this embodiment, two frequencies f1, f2 in the two-frequency CW system are generated by the switching within the time interval t2 (interval of the second period). However, only the signal having reached within the predetermined time is processed because of the timing of the switching operation of such frequency.

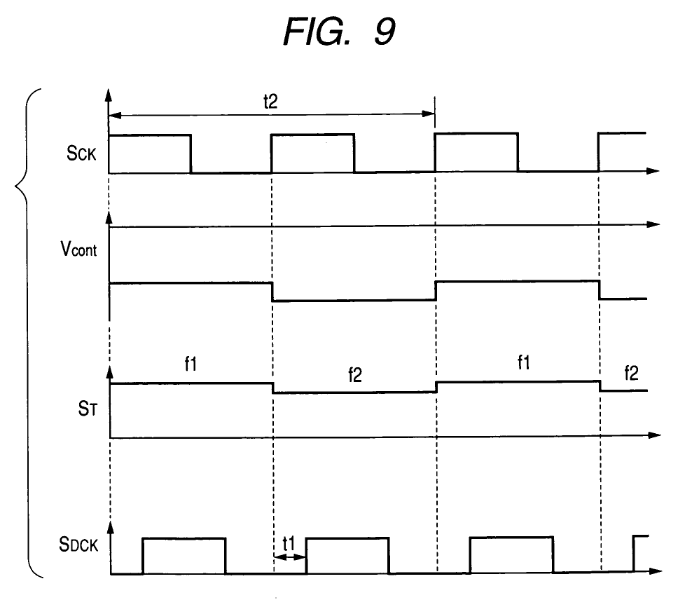

In FIG. 8, the voltage-controlled oscillator 1 is controlled in the oscillation frequency with the control voltage generator 2 controlled with the clock generator 18. FIG. 9 illustrates a timing chart for the control. In the example of FIG. 9, the control voltage V_{CONT} is switched by detecting rise of the clock signal S_{CK}. In the case of the circuit example of the voltage-controlled oscillator 1 illustrated in FIG. 2, since the control voltage V_{CONT} for adjusting the frequency has a negative value, the control voltage V_{CONT} in the timing chart of FIG. 9 has also a negative value. The transmitting signal S_{T} generated by the control voltage is illustrated in the same figure by plotting the frequency in the vertical axis.

The transmitting signal S_{T} is radiated from the antenna 4 and the reflection signal from the object located nearer than the effective distance Rₘₐₓ reaches the radar system with a short time delay, while the reflection signal from the object located further than the Rₘₐₓ reaches with a large time delay because the propagation distance of signal is longer. The reflection signal having reached the receiving antenna 5 becomes the receiving signal. The receiving signal is subjected to the A/D conversion with the A/D converter 16 and is also processed by the FFT or the like with the signal processing circuit (FFT)

In this timing, the clock signal SCK and the timing clock S_{DCK} which is delayed by a constant period t1 (first period) with a delay circuit (DELAY) 3 are inputted to the A/D converter 16. The A/D converter 16 starts the operation with the rise time of the clock S_{CK} and stops operation with the rise time of the timing clock S_{DCK}. Therefore, the A/D converter 16 operates only within the time length t1.

The reflection signal from the target located further than the effective distance Rₘₐₓ requires the period equal to or longer than t1 until it reaches the radar system from the switching of the frequency of the transmitting signal S_{T}. However, since the frequency of the transmitting signal S_{T} does not change until the next switching of frequency, the low frequency signal having the Doppler frequency element passes the low-pass filter 15 in this timing. Since the A/D converter 16 does not operate during the period up to the next frequency switching from the time t1, this low frequency signal is eliminated. Accordingly, only the signal from the target located nearer than the effective distance Rₘₐₓ can be processed.

This embodiment can provide the merit that since the necessary operations are executed in the low frequency circuit, a high frequency circuit such as switch is not required and the system can be formed with only simple circuit structure like the ordinary two-frequency CW system.

From above description, this embodiment is a radar system for processing only the signal received within the predetermined period t1 from the time of frequency switching, in the two-frequency CW system for detecting the distance up to the object by radiating two electromagnetic waves of the frequencies which are different a little through the switching of the time and receiving the electromagnetic wave reflected by the object.

### FOURTH EMBODIMENT

The embodiments described above are formed by introducing the two-frequency CW system, but the present invention can naturally be adapted effectively to the system other than the two-frequency CW system.

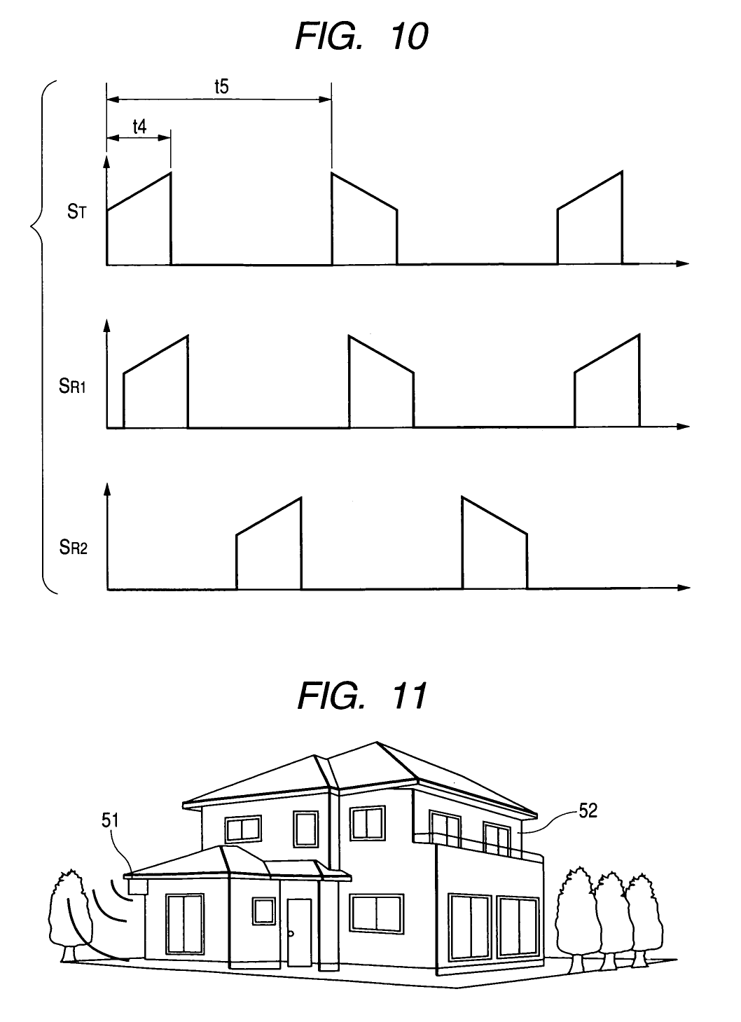

FIG. 10 illustrates a fourth embodiment employed into the FMCW radar as an example of other applications. Frequency is plotted on the vertical axis, while time on the horizontal axis. In the case of FMCW radar, in order to improve the distance resolution, the frequency must be swept in a larger inclination because the distance is measured from the frequency. However, in the radar system using ultra-high frequency signal such as the millimeter wave, it is very difficult to form the voltage-controlled oscillator having sufficient sweep width. Therefore, the sweep period must be shortened to maintain the sufficient distance resolution while the frequency seep width is small. Meanwhile, if the target located at the position requiring propagation time of the electromagnetic wave which is longer than the repetition frequency of the frequency sweep is detected, this signal is detected as the reflection signal from the target which should not truly exist, namely detected as the ghost. Therefore, in this embodiment, the frequency sweep time is limited to a certain time t4 and the repetition period t5 of frequency sweep is also set. Here, t4 is the time length expressed by the following formula under the condition of t4<tk, considering the time tk which is determined by the maximum frequency sweep width determined by the performance of the voltage-controlled oscillator and the following formula.

$${t}_{4} < {t}_{k} = \frac{2 {R}_{spec2}}{C}$$

Moreover, the frequency repetition period t5 is the time length determined by the following formula.

$$t5 > \frac{2 {R}_{lim}}{C} + t4$$

Here, R_{spec2} is the maximum detection distance given considering the required specification of the radar system. Rₗᵢₘ is the detection limit distance of the object showing the maximum reflection amount of the electromagnetic wave which is assumed from the performance of radar system and environment for use. Detection of object is conducted using the signal identical to the transmitting signal in the time length t4 and period t5.

According to this embodiment, since generation of ghost can be suppressed even when the frequency sweep period is reduced, it is possible to attain the merit that frequency sweep for wider frequency band is not required.

From above description, this embodiment is the radar system for radiating the electromagnetic wave only for the predetermined period t4 with the predetermined time interval of t5 and processing the signal received within the predetermined period t4 from radiation of the electromagnetic wave, in the radar system for detecting the distance up to the object by radiating the frequency-modulated electromagnetic wave and receiving the electromagnetic wave reflected from the object.

The radar system of the present invention for detecting the distance up to the object by radiating the frequency-modulated electromagnetic wave and receiving the electromagnetic wave reflected by the object may also include the radar system for switching the center frequency of the electromagnetic wave radiated in every predetermined time and processing the signal received within the predetermined period from the time of frequency switching.

The first to fourth embodiments described above are all radar systems for measuring the distance up to the object using the electromagnetic waves but the present invention can naturally be adapted, with possibility for attaining the identical effects, to the distance measuring apparatus for measuring the distance with similar method by utilizing the other media such as light and ultrasonic wave.

### FIFTH EMBODIMENT

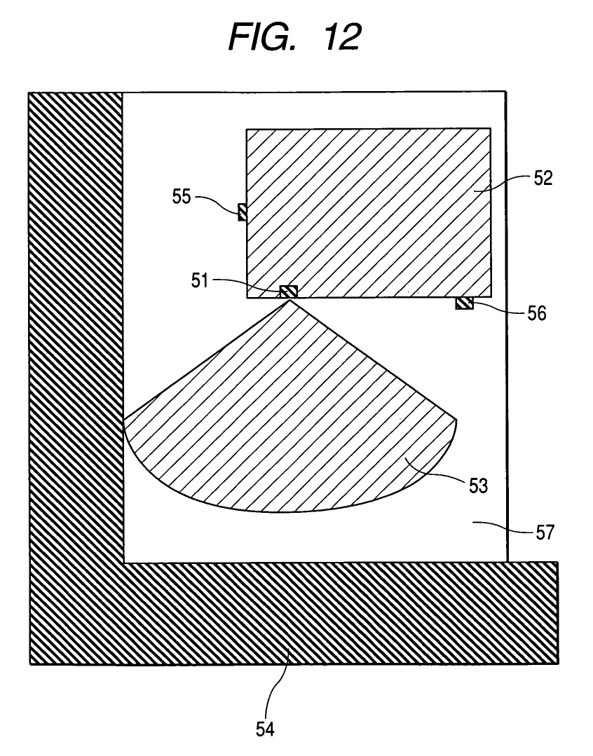

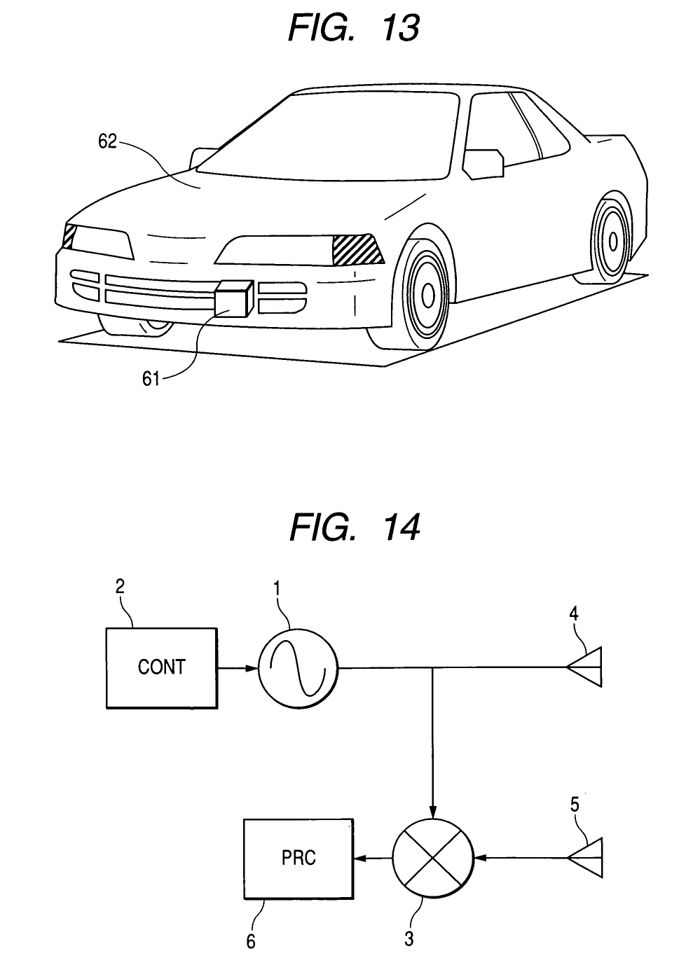

FIG. 11 illustrates a fifth embodiment in which the radar system of the present invention is utilized into a trespasser monitoring radar for an ordinary house. Moreover, FIG. 12 illustrates a layout of the residential area including a house, a site, and peripheral roads viewed from the upper side. The radar system 51 is installed to the house 52 for monitoring a trespasser intruding into the site 57. This radar system has the performance for detecting a human body located in the detection range 53. In order to reduce the dead-band of the radar system within the site, a plurality of radar systems 55, 56 are installed as required.

Here, in the case of the radar system which can detect human body within the detection range 53, if a substance which shows a large amount of reflection of the electromagnetic wave such as a vehicle passes the road 54 located in the outside of the site, the radar system detects this substance and is likely to generate ghost. Therefore, generation of ghost can be prevented by setting the effective distance R_{spec1} to be matched with the detection range 53 and eliminating the reflection signal from the object located in the outside of this detection range.

According to this embodiment, it is possible to achieve the merit that a human body can be detected with the higher resolution even when a substance like a human body showing a small amount of reflection of the electromagnetic wave is considered as the detection object because Δf can be set with reference to the detection limit distance of this substance.

The radar system of this embodiment can also be used for improvement in prevention of crime by simultaneously setting a camera. In this case, the radar system outputs any of the information pieces such as location, direction, and distance of the object and the camera executes image processes based on the data outputted from the radar system. The object can be identified easily by processing the image.

### SIXTH EMBODIMENT

FIG. 13 illustrates a sixth embodiment of the radar system of the present invention which is used for a vehicle radar. In this embodiment, the radar system 61 is installed to the front area of the vehicle 62 to monitor the distance up to a vehicle and an obstacle located within the distance of 50 m from the relevant vehicle. When the distance up to a vehicle or an obstacle located in front of this vehicle becomes shorter and the vehicle is judged to collide with a vehicle or an obstacle, an airbag is operated and tension of a seat belt is intensified, in view of ensuring safety of a driver and passengers when the vehicle collides.

In this embodiment, the radar system is installed in the front side of the vehicle but similar effect can also be obtained by monitoring the peripheral area of the vehicle by installing the system in the rear side or both sides of the vehicle. In the case of measuring the distance up to an object located comparatively nearer from the vehicle with higher accuracy, it is effective to set Δf to a larger value in order to improve distance resolution of the radar system. However, on the other hand, when the radar system has higher performance and the detection limit distance exceeds the distance to be monitored, ghost is sometimes generated and it is very dangerous. Therefore, generation of ghost can be prevented by setting the effective distance R_{spec1} to be matched with the desired detection range and eliminating the reflection signal from the object located in the outside of this range.

In this embodiment, the radar system for short distance to monitor the distance within 50 m has been described. However, when the radar performance is sufficiently larger for the required specification without relation to the monitoring range such as the radar systems for monitoring long distance and short distance, Δf can be set to a larger value up to the required specification and it can be expected to realize the radar system having the higher resolution.

What is claimed is:

1. A radar system comprising:
a signal generator for generating a transmitting signal;
an antenna for radiating electromagnetic wave by inputting the transmitting signal outputted from the signal generator;
a receiving antenna for receiving the electromagnetic wave reflected from an object; and
a detector for detecting distance up to the object from the receiving signal outputted from the receiving antenna,
wherein the transmitting signal continues for a first time length with an interval of a second time length; and
wherein the detector detects the distance up to the object by processing the receiving signal received up to a third period from the beginning of the first period.

2. The radar system according to claim 1, wherein the third period is almost matched with the first period.

3. The radar system according to claim 1, wherein the transmitting signal is formed of two signals of different frequencies and these two signals continue respectively for the first period with an interval of the second period, and the detector detects the distance up to the object by processing two signals received up to the third period from the start of the first period.

4. A radar system comprising:
a signal generator for generating the transmitting signal;
an antenna for radiating the electromagnetic wave by inputting the electromagnetic wave reflected by an object;
a receiving antenna for receiving the electromagnetic wave reflected by the object; and
a detector for detecting the distance up to the object from the receiving signal outputted from the receiving antenna,
wherein the transmitting signal is the signal which is alternately switched in two frequencies and becomes equal in the frequency with an interval of a second period and the detector can detect the distance up to the object by processing the receiving signal received up to a first period from the time of frequency switching.

5. A radar system comprising:
a signal generator for generating the transmitting signal;
an antenna for radiating the electromagnetic wave by inputting the transmitting signal outputted from the signal generator;
a receiving antenna for receiving the electromagnetic wave reflected by the object; and
a detector for detecting the distance up to the object from the receiving signal outputted from the receiving antenna,
wherein the transmitting signal is the frequency modulated signal which is swept in the frequency during a first time length and continued with an interval of a second period and the detector detects the distance up to the object by processing the receiving signal received up to a third period from the start of a first period.

6. The radar system according to claim 5, wherein the third period is almost matched with the first period.

7. The radar system according to claim 1, wherein the system is installed in a residential area including a house and a site to detect an object which is intruding into the residential area.

8. The radar system according to claim 4, wherein the system is installed in a residential area including a house and a site to detect an object which is intruding into the residential area.

9. The radar system according to claim 5, wherein the system is installed in a residential area including a house and a site to detect an object which is intruding into the residential area.

10. The radar system according to claim 1, wherein the system is installed in a vehicle to detect the distance up to an object located around the vehicle.

11. The radar system according to claim 4, wherein the system is installed in a vehicle to detect the distance up to an object located around the vehicle.

12. The radar system according to claim 5, wherein the system is installed in a vehicle to detect the distance up to an object located around the vehicle.
